(19) United States
(12) Patent Application Publication
(10) Pub. No.: US 2022/0097764 A1
(43) Pub. Date: Mar. 31, 2022

(54) STEERING SYSTEM FOR ARTICULATED VEHICLE

(71) Applicant: Artisan Vehicle Systems, Inc., Camarillo, CA (US)

(72) Inventors: Kyle Hickey, Moorpark, CA (US); Brian R. Huff, Newberry Park, CA (US); Gaurav Mehta, Great Sudbury (CA); Christopher Vochoska, Simi Valley, CA (US)

(21) Appl. No.: 17/034,066

(22) Filed: Sep. 28, 2020

(51) Int. Cl. B62D 12/00; B60W 10/188; B60W 10/20; B60W 30/045; B60W 10/08

(52) U.S. Cl. CPC B62D 12/00; B60W 10/188; B60W 10/08; B60W 30/045; B60W 10/20

(57) ABSTRACT

In one aspect, the present disclosure is directed to an articulated vehicle. The vehicle may include a device processor and a non-transitory computer readable medium including instructions stored thereon and executable by the device processor for controlling articulation of the vehicle by performing the following steps: utilizing the front drive system to apply drive power to the pair of front wheels; actuating brakes associated with the second front wheel to counteract the application of drive power to the second front wheel; utilizing the rear drive system to apply drive power to the pair of rear wheels; and actuating brakes associated with the first rear wheel to counteract the application of drive power to the first rear wheel.

### BACKGROUND

### 1. Field of the Invention

The present disclosure is directed to a steering system for an articulated vehicle and, more particularly, to a steering system utilizing select control of individual wheel speed and/or direction of rotation.

### 2. Description of Related Art

Machines and vehicles with multiple segments may be steered by articulation between the segments. Actuation of the articulation is performed by one or more hydraulic cylinders bridging between the articulated vehicle segments. In some cases, the vehicle may include an electrically powered drive system. For example, the vehicle may be powered by one or more electric power sources (e.g., batteries) instead of an internal combustion engine. For a vehicle at a work site, such as a mine, there are certain driving modes that use only minimal steering input. Nevertheless, since the articulated steering is hydraulically operated, the entire hydraulic system must be kept pressurized, powered up, and running even to make the most minute steering inputs.

The present disclosure is directed to drive systems that address one or more of the issues discussed above.

### SUMMARY

The present disclosure is directed to a steering system for an articulated vehicle that is auxiliary to the hydraulic steering system. In particular, the steering system may utilize selective control of individual wheel speed and/or direction of wheel rotation to articulate the vehicle independent of the hydraulic steering system. For example, in some embodiments, the hydraulic steering valve may be opened so that fluid may flow in and out of the hydraulic steering cylinders freely, thus rendering the hydraulic steering cylinders passively movable. In some cases, the hydraulic system may even be turned off to conserve energy. This conservation of energy may be particularly beneficial for a vehicle that utilizes an electric power source.

In one aspect, the present disclosure is directed to an articulated vehicle. The vehicle may include a front chassis segment including a pair of front wheels including a first front wheel on a first side of the vehicle and a second front wheel on a second, opposite side of the vehicle; a rear chassis segment including a pair of rear wheels, including a first rear wheel on the first side of the vehicle and a second rear wheel on the second side of the vehicle; and an articulating joint between the front chassis segment and the rear chassis segment. In addition, the vehicle may include at least one actuation device configured to control the articulation of the articulating joint. Further, the vehicle may include a front drive system configured to drive the first front wheel and the second front wheel; and a rear drive system configured to drive the first rear wheel and the second rear wheel. Also, the vehicle may include a braking system including brakes that are individually actuatable for each wheel of the vehicle. In addition, the vehicle may include a controller including a device processor and a non-transitory computer readable medium including instructions stored thereon and executable by the device processor for controlling articulation of the vehicle by performing the following steps: utilizing the front drive system to apply drive power to the pair of front wheels; actuating brakes associated with the second front wheel to counteract the application of drive power to the second front wheel; utilizing the rear drive system to apply drive power to the pair of rear wheels; and actuating brakes associated with the first rear wheel to counteract the application of drive power to the first rear wheel.

In another aspect, the present disclosure is directed to an articulated vehicle. The vehicle may include a front chassis segment including a pair of front wheels including a first front wheel on a first side of the vehicle and a second front wheel on a second, opposite side of the vehicle; a rear chassis segment including a pair of rear wheels, including a first rear wheel on the first side of the vehicle and a second rear wheel on the second side of the vehicle; and an articulating joint between the front chassis segment and the rear chassis segment. The vehicle may also include at least one actuation device configured to control the articulation of the articulating joint. In addition, the vehicle may include a first electric motor configured to drive the first front wheel; a second electric motor configured to drive the second front wheel; a third electric motor configured to drive the first rear wheel; and a fourth electric motor configured to drive the second rear wheel. Also, the vehicle may include a controller including a device processor and a non-transitory computer readable medium including instructions stored thereon and executable by the device processor for controlling articulation of the vehicle by performing the following steps: applying a first level of drive power to the first front wheel; and applying a second level of drive power to the second front wheel to drive the second front wheel at a slower speed than the first front wheel.

In another aspect, the present disclosure is directed to n articulated vehicle. The vehicle may include a front chassis segment including a pair of front wheels including a first front wheel on a first side of the vehicle and a second front wheel on a second, opposite side of the vehicle; a rear chassis segment including a pair of rear wheels, including a first rear wheel on the first side of the vehicle and a second rear wheel on the second side of the vehicle; and an articulating joint between the front chassis segment and the rear chassis segment. In addition, the vehicle may include at least one actuation device configured to control the articulation of the articulating joint. Further, the vehicle may include a first electric motor configured to drive the first front wheel; a second electric motor configured to drive the second front wheel; a third electric motor configured to drive the first rear wheel; and a fourth electric motor configured to drive the second rear wheel. Also, the vehicle may include a controller including a device processor and a non-transitory computer readable medium including instructions stored thereon and executable by the device processor for correcting a cornering line of the vehicle by performing the following steps: driving the pair of front wheels in a first direction; and driving the pair of rear wheels in a second direction opposite the first direction in order to move the vehicle laterally.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

### BRIEF DESCRIPTION OF THE DRAWINGS

The embodiments can be better understood with reference to the following drawings and description. The components in the figures are not necessarily to scale, with emphasis instead being placed upon illustrating the principles of the embodiments. Moreover, in the figures, like reference numerals designate corresponding parts throughout the different views.

FIG. 1 is a schematic illustration of an articulated vehicle, according to an embodiment;

FIG. 2 is a schematic block diagram of a steering system of the vehicle shown in FIG. 1;

FIG. 3 is a schematic top view of the vehicle of FIG. 1 unarticulated and traveling in a straight line;

FIG. 4 is a schematic top view of the vehicle of FIG. 1 in an articulated condition;

FIG. 5 is a flowchart illustrating a method of controlling articulation of the vehicle of FIG. 1;

FIG. 6 is a schematic illustration of an articulated vehicle, according to another embodiment;

FIG. 7 is a schematic block diagram of a steering system of the vehicle shown in FIG. 6;

FIG. 8 is a schematic top view of the vehicle of FIG. 6 unarticulated and traveling in a straight line;

FIG. 9 is a schematic top view of the vehicle of FIG. 6 in an articulated condition;

FIG. 10 is a flowchart illustrating a method of controlling articulation of the vehicle of FIG. 6;

FIG. 11 is a schematic top view of the articulated vehicle of FIG. 6 making an alteration to the cornering line of the vehicle; and

FIG. 12 is a flowchart illustrating a method of altering the cornering line of the vehicle of FIG. 6.

### DETAILED DESCRIPTION

The disclosed embodiments are directed to articulated vehicles. For purposes of this disclosure, the term “articulated vehicle” will be understood to refer to a vehicle with a front segment and a rear segment attached to the front segment in an articulatable manner and in which the vehicle is steered by controlling the articulation of the vehicle.

In some embodiments, the disclosed concepts may be implemented in a vehicle configured for use in mining operations. For example, the accompanying figures illustrate vehicles configured for use in underground mining operations. It will be understood, however, that the disclosed drive system concepts may be implemented in any of various types of vehicles, including, for example, road-going vehicles, off-road vehicles, work machines, mining vehicles, space vehicles, and any other type of vehicle.

In some embodiments, the disclosed concepts may be implemented in an electric vehicle. The vehicle includes at least two electric motors. For example, one motor may be operatively connected to each axle. In some embodiments, an electric motor may be operatively connected to each individual wheel. In some embodiments, the vehicle may be driven solely by electric power. In other embodiments, the vehicle may be a hybrid vehicle, operating on a combination of electric power and an internal combustion engine. For example, in some cases, one axle may be driven by power from a combustion engine, and a second axle may be driven by electrical power.

As used herein, the term “fixedly attached” shall refer to two components joined in a manner such that the components may not be readily separated (for example, without destroying one or both components). The term “removably attached” shall refer to components that are attached to one another in a readily separable manner (for example, with fasteners, such as bolts, screws, etc.).

As used herein, the terms “up,” “upper,” “top,” “height,” etc., and “down,” “lower,” “bottom,” etc. shall refer to components and locations along a substantially vertical direction. Such terms shall be used with respect to the disclosed vehicles with the wheels on the ground (or floor) as intended during use.

In some embodiments, the brakes may be actuated selectively on individual wheels in order to articulate the vehicle to thereby steer the vehicle.

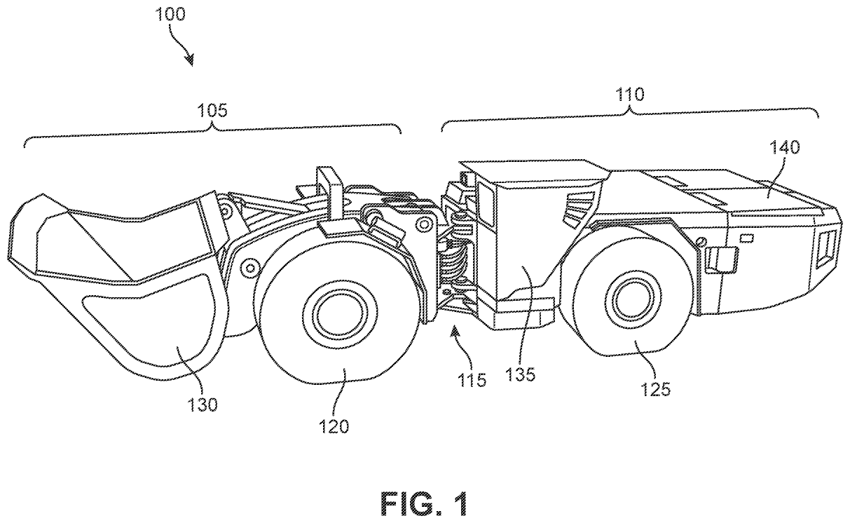

FIG. 1 is a schematic illustration of an articulated vehicle, according to an embodiment. As shown in FIG. 1, an articulated vehicle 100 may include a front chassis segment 105 including a pair of front wheels 120, a rear chassis segment 110 including a pair of rear wheels 125, and a mechanical linkage such as an articulating joint 115 between front chassis segment 105 and rear chassis segment 110.

As shown in FIG. 1, in some embodiments, vehicle 100 may be a bucket loader type vehicle. Accordingly, as shown in FIG. 1, vehicle 100 may include a bucket 130 attached as part of front chassis segment 105. As also shown in FIG. 1, vehicle 100 may include an operator cab 135 attached as part of rear chassis segment 110. In some embodiments, vehicle 100 may be an underground mining vehicle. That is, vehicle 100 may be sized and configured to fit within standard sized mining shafts. It will be understood that, although FIG. 1 is illustrated as a mining loader, the steering features discussed below may be applicable to any type of articulated vehicle.

In some embodiments, vehicle 100 may be an electrically powered vehicle. Accordingly, as shown in FIG. 1, vehicle 100 may include one or more battery packs 140. Vehicle 100 includes the battery packs 140 on the rear chassis segment 110. However, in some embodiments, the battery packs could be provided on the front chassis segment. In still other embodiments, battery packs could be provided on both chassis segments.

In some embodiments, the vehicle may be provided with a primary steering system and an auxiliary steering system. For example, in some embodiments, the vehicle may include a primary steering system that includes hydraulic cylinders and/or another type of actuator, such as an electric motor. The hydraulic cylinders and/or electric motors may be provided on either or both sides of the articulating joint between chassis segments, and may lengthen or shorten in order to articulate the vehicle. The auxiliary steering system may be an electronically controlled braking system that selectively controls braking at individual wheels in order to individually regulate wheel speed at each corner of the vehicle. The vehicle may be configured to render the hydraulic cylinders or electric motors of the primary steering system inactive and passive, allowing the chassis forces caused by selective braking of individual wheels to articulate the vehicle.

In some embodiments, during certain activities, the primary steering system may be turned off while the auxiliary system is in use. For example, mining vehicles often drive over significant distances without requiring much steering input. This type of driving is referred to as “tramming.” When tramming, the vehicle may turn off the primary steering system (e.g., by turning off the hydraulic system or merely depressurizing it, for example, by turning off the hydraulic pump) and utilize selective braking on individual wheels to steer the vehicle. In some embodiments, a tramming mode with this functionality may be selectable by the vehicle operator. In some embodiments, the vehicle may automatically enter tramming mode after a period of time in which the vehicle has been operated without much steering input.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

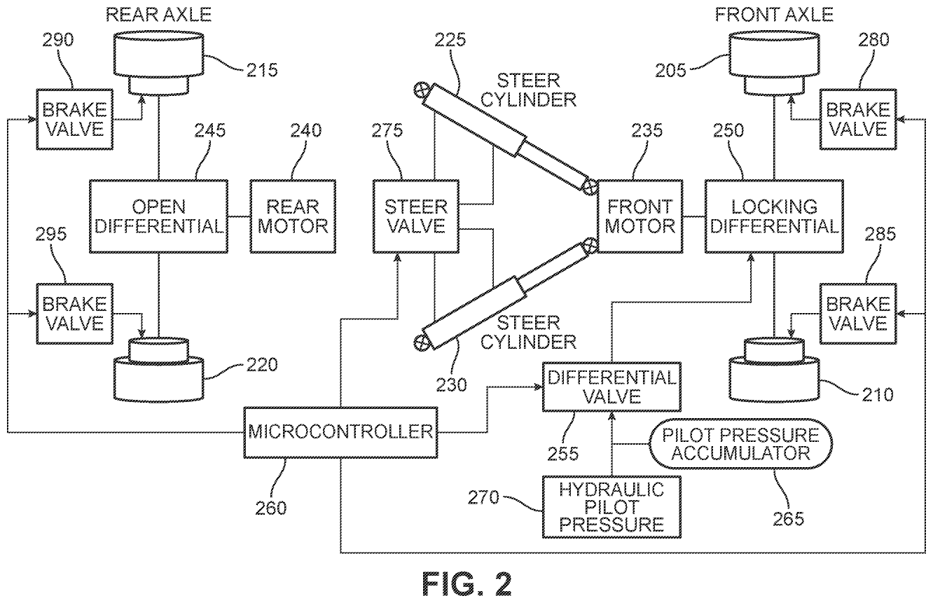

FIG. 2 is a schematic block diagram of a steering system of the vehicle shown in FIG. 1. FIG. 2 illustrates components of both the primary steering system and the auxiliary steering system. As shown in FIG. 2, the front pair of wheels may include a first front wheel 205 on a first side of the vehicle and a second front wheel 210 on a second, opposite side of the vehicle. In addition, the rear pair of wheels may include a first rear wheel 215 on the first side of the vehicle and a second rear wheel 220 on the second side of the vehicle.

FIG. 2 also shows at least one type of actuation device configured to control articulation of the articulating joint between the front chassis segment and the rear chassis segment. In particular, FIG. 2 illustrates a hydraulic primary steering system. Accordingly, FIG. 2 illustrates a first hydraulic steering cylinder 225 on the first side of the vehicle and a second hydraulic steering cylinder 230 on the second, opposite side of the vehicle.

In some embodiments, the vehicle may include dual drive systems. For example, as shown in FIG. 2, the vehicle may include a front drive system configured to drive first front wheel 205 and second front wheel 210, and a rear drive system configured to drive first rear wheel 215 and second rear wheel 220. As shown in FIG. 2, the vehicle may include a front propulsion motor 235 configured to drive first front wheel 205 and second front wheel 210. In addition, the vehicle may also include a rear propulsion motor 240. In some embodiments, one or both of front propulsion motor 235 and rear propulsion motor 240 may be electric motors.

The vehicle may also include a differential on each axle. In some embodiments, as shown in FIG. 2, the vehicle may include a front locking differential 250, which selectively operatively connects first front wheel 205 to second front wheel 210. Front locking differential 250 may be electronically controllable by the operator. For a loader vehicle, it is desirable for the differential between the front wheels to be locked while the vehicle is scooping material with the bucket. However, in order to facilitate selective braking of individual wheels, a locking front differential may be used in order to permit the differential to be unlocked when the vehicle is not actively scooping material with the bucket.

Front locking differential 250 may be locked and unlocked hydraulically. In order to lock and unlock front locking differential 250, a differential valve 255 may be controlled by a controller 260. The hydraulic system associated with front locking differential 250 may also include a pilot pressure accumulator 265 and a hydraulic pump 270 that produces hydraulic pilot pressure. Controller 260 may control differential valve 255 in order to regulate the amount of hydraulic pressure that is delivered to front locking differential 250 to thereby lock and unlock the differential.

As shown in FIG. 2, the vehicle may also include a rear open differential 245, which operatively connects first rear wheel 215 with second rear wheel 220. Rear propulsion motor 240 may apply power to the rear pair of wheels through rear open differential 245. Absent outside forces, rear open differential 245 may ensure that first rear wheel 215 and second rear wheel 220 spin at the same speed. However, since the differential is an open differential, rear open differential 245 may permit outside forces, such as select braking on individual wheels, to change the speed of rotation of one or both wheels that are operatively connected to rear open differential 245.

The vehicle may also include a braking system including brakes that are individually actuatable for each wheel of the vehicle. For example, as shown in FIG. 2, the braking system may be hydraulic and a hydraulic brake valve may be provided on each wheel. The brake valves may be individually controllable by the controller to actuate the brakes on each individual wheel. As shown in FIG. 2, a first brake valve 280 may be configured to brake first front wheel 205. A second brake valve 285 may be configured to brake second front wheel 210. A third brake valve 290 may be configured to brake first rear wheel 215. Further, a fourth brake valve 295 may be configured to brake second rear wheel 220.

Controller 260 may include various computing and communications hardware, such as servers, integrated circuits, displays, etc. Further, controller 260 may include a device processor and a non-transitory computer readable medium, such as a memory, including instructions executable by a device processor to perform the processes discussed herein. For example, the computer readable medium may include instructions stored thereon and executable by the device processor for controlling articulation of the vehicle.

The non-transitory computer readable medium may include any suitable computer readable medium, such as a memory, e.g., RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, a read-only memory (ROM), a random access memory (RAM), a static random access memory (SRAM), a portable compact disc read-only memory (CD-ROM), an erasable programmable read-only memory (EPROM or Flash memory), a digital versatile disk (DVD), a memory stick, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire. Controller 260 may include networking hardware configured to interface with other nodes of a network, such as a LAN, WLAN, or other networks. In some cases, communications between components may be made via the Internet, a cellular network, WIFI, or other suitable communications network.

Any suitable communication platforms and/or protocols may be utilized for communication between controller 260 and other components of the system. Since the various sources of information may each have their own platform and/or protocol, the system may be configured to interface with each platform and/or protocol to receive the data.

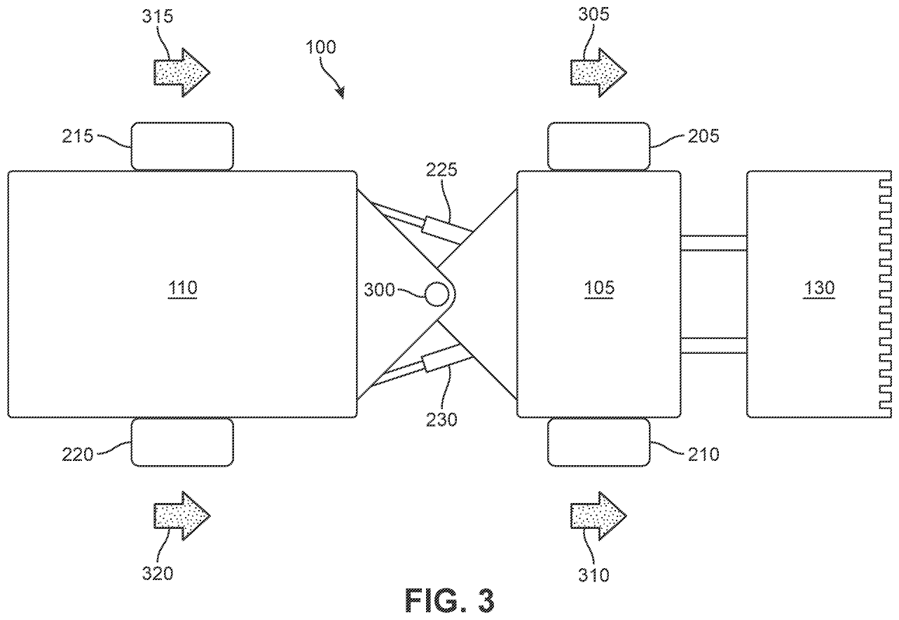

FIG. 3 is a schematic top view of the vehicle of FIG. 1 unarticulated and traveling in a straight line. While traveling in a straight line, the wheel speed may be substantially the same at each wheel, as indicated by equally sized arrows. That is, a first arrow 305 indicates the wheel speed of first front wheel 205, a second arrow 310 indicates the wheel speed of second front wheel 210, a third arrow 315 indicates the wheel speed of first rear wheel 215, and a fourth arrow 320 indicates the wheel speed of second rear wheel 220. As also shown in FIG. 3, when traveling in a straight line, vehicle 100 is unarticulated about an articulating joint 300. In the unarticulated condition, first hydraulic steering cylinder 225 and second hydraulic steering cylinder 230 are substantially the same length, as shown in FIG. 3.

In some embodiments, the computer readable medium may include instructions for articulating the vehicle using the braking system. For example, the computer readable medium may include instructions for utilizing the front drive system to apply drive power to the pair of front wheels and actuating brakes associated with the second front wheel to counteract the application of drive power to the second front wheel. In addition, the computer readable medium may include instructions for utilizing the rear drive system to apply drive power to the pair of rear wheels, and actuating brakes associated with the first rear wheel to counteract the application of drive power to the first rear wheel. By actuating the brakes at opposing corners of the vehicle, a torque may be created about articulating joint 300. The torque may be permitted to articulate the vehicle. Thus, selective braking of individual wheels may be utilized to steer the vehicle.

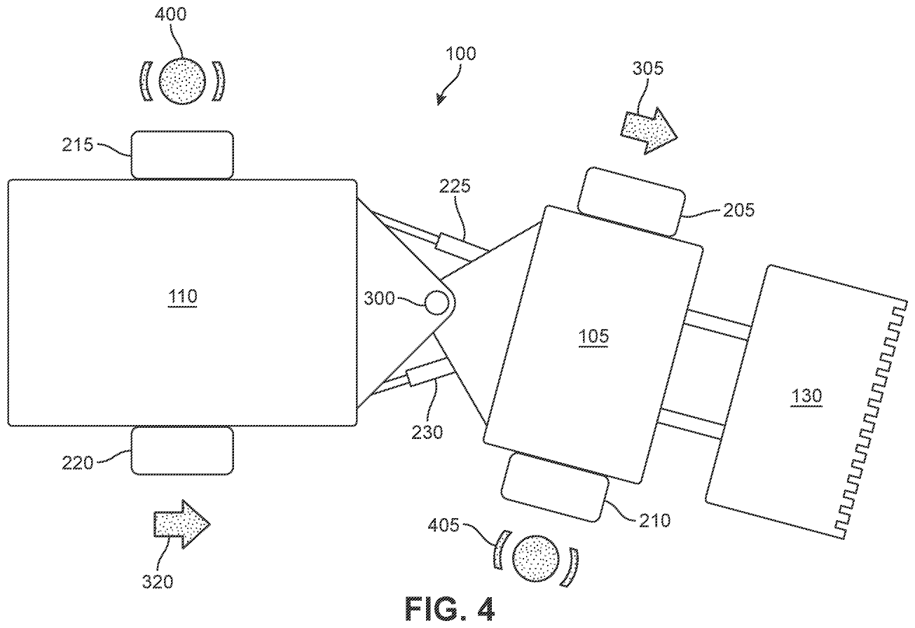

FIG. 4 is a schematic top view of the vehicle of FIG. 1 in an articulated condition. In FIG. 4, first front wheel 205 is shown traveling at a given speed indicated by first arrow 305 and second rear wheel 220 is shown traveling at substantially the same speed indicated by fourth arrow 320. In addition, a first braking symbol 405 indicates that second front wheel 210 is being selectively braked to reduce the speed compared to first front wheel 205. Similarly, a second braking symbol 400 indicates that first rear wheel 215 is being selectively braked to reduce the speed of first rear wheel 215 relative to second rear wheel 220. Upon the application of these unbalanced wheel speeds, the chassis segments of vehicle 100 may articulate with respect to one another about articulating joint 300. It will be understood that, although vehicle 100 includes hydraulic steering cylinders, the auxiliary steering system utilizing selective braking of individual wheels may be equally applicable to articulated vehicles that use other types of actuation devices to control articulation as the primary steering system. For example, instead of hydraulic steering cylinders, the vehicle may include electric motors to articulate the vehicle as the primary steering system.

In order to permit articulation by the auxiliary steering system, the primary steering system may be rendered passive. For example, in a vehicle with a hydraulic primary steering system, such as vehicle 100, the valve or valves associated with first hydraulic steering cylinder 225 and second hydraulic steering cylinder 230 may be opened to permit fluid to easily flow in and out of the cylinders. This permits articulation of the vehicle from secondary forces, such as selective braking of individual wheels. It will be understood that the valves associated with the hydraulic steering cylinders may be integrated with the cylinders themselves or provided as separate components of the hydraulic system. Further, it will also be understood that, in some embodiments, the hydraulic steering system may include two or more steering valves.

In addition, in some embodiments, the non-transitory computer readable medium of the controller may further include instructions for turning off a hydraulic system associated with the hydraulic steering cylinders prior to controlling articulation of the vehicle via selective braking of the individual wheels of the vehicle. For example, during tramming, the hydraulic pump or the entire hydraulic system may be turned off, thus conserving energy.

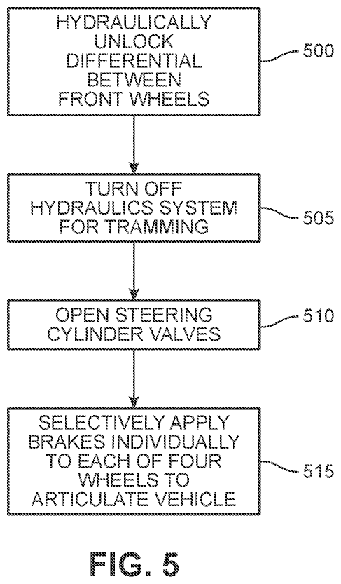

FIG. 5 is a flowchart illustrating a method of controlling articulation of the vehicle of FIG. 1. As illustrated in FIG. 5, the method may include a first step of hydraulically unlocking a differential between front wheels of the vehicle. (Step 500.) In addition, the method may include turning off the hydraulics system, e.g., for tramming. (Step 505.) Further, the method may include a step of opening the valves associated with the steering cylinders. (Step 510. Also, the method may include selectively applying braking to individual wheels of the vehicle to articulate the vehicle. (Step 515.)

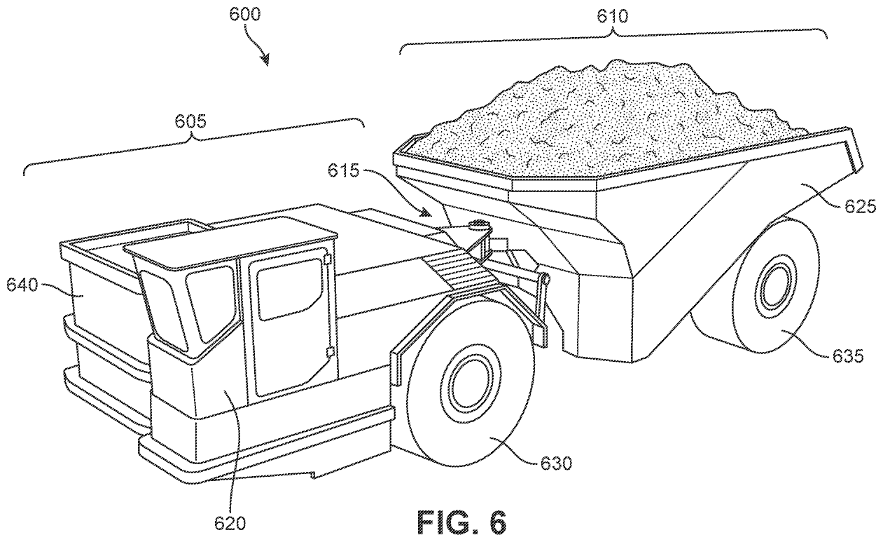

FIG. 6 is a schematic illustration of an articulated vehicle, according to another embodiment. As shown in FIG. 6, an articulated vehicle 600 may include a front chassis segment 605 including a pair of front wheels 630, a rear chassis segment 610 including a pair of rear wheels 635, and a mechanical linkage such as an articulating joint 615 between front chassis segment 605 and rear chassis segment 610.

As shown in FIG. 6, in some embodiments, vehicle 600 may be a hauling type vehicle, sometimes referred to as a “load haul dump” vehicle or “LHD.” Accordingly, as shown in FIG. 6, vehicle 600 may include a bed 625 attached as part of rear chassis segment 610. As also shown in FIG. 6, vehicle 600 may include an operator cab 620 attached as part of front chassis segment 605. In some embodiments, vehicle 100 may be an underground mining vehicle. That is, vehicle 600 may be sized and configured to fit within standard sized mining shafts. It will be understood that, although FIG. 6 is illustrated as a mining LHD, the steering features discussed below may be applicable to any type of articulated vehicle.

In some embodiments, vehicle 600 may be an electrically powered vehicle. Accordingly, as shown in FIG. 6, vehicle 600 may include one or more battery packs 640. Vehicle 600 includes the battery packs 640 on the front chassis segment 605. However, in some embodiments, the battery packs could be provided on the rear chassis segment. In still other embodiments, battery packs could be provided on both chassis segments.

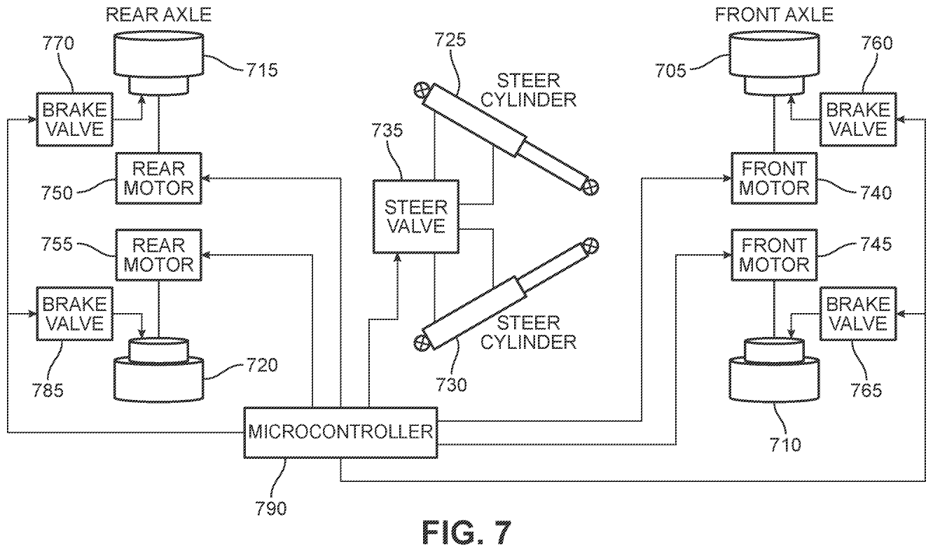

FIG. 7 is a schematic block diagram of a steering system of the vehicle shown in FIG. 6. FIG. 7 illustrates components of both the primary steering system and the auxiliary steering system of the vehicle shown in FIG. 6. As shown in FIG. 7, the front pair of wheels may include a first front wheel 705 on a first side of the vehicle and a second front wheel 710 on a second, opposite side of the vehicle. In addition, the rear pair of wheels may include a first rear wheel 715 on the first side of the vehicle and a second rear wheel 720 on the second side of the vehicle.

FIG. 7 also shows at least one type of actuation device configured to control articulation of the articulating joint between the front chassis segment and the rear chassis segment. In particular, FIG. 7 illustrates a hydraulic primary steering system. Accordingly, FIG. 7 illustrates a first hydraulic steering cylinder 725 on the first side of the vehicle and a second hydraulic steering cylinder 730 on the second, opposite side of the vehicle. The hydraulic steering system may also include a hydraulic steering valve 735 configured to regulate the flow in and out of first hydraulic steering cylinder 725 and second hydraulic steering cylinder 730. It will be understood that steering valve 735 may be integrated with each steering cylinder or may be a separate component of the hydraulic steering system. Further, it will also be understood that the hydraulic steering system may include two or more steering valves.

In some embodiments, the vehicle may include a multi-drive propulsion system. For example, as shown in FIG. 7, the vehicle may include a separate propulsion motor, such as an electric motor, configured to drive each wheel. Accordingly, the vehicle may include a first propulsion motor 740 configured to drive first front wheel 705, a second propulsion motor 745 configured to drive second front wheel 710, a third propulsion motor 750 configured to drive first rear wheel 715, and a fourth propulsion motor 755 configured to drive second rear wheel 720. In some embodiments, one or more of first propulsion motor 740, second propulsion motor 745, third propulsion motor 750, and fourth propulsion motor 755 may be electric motors.

As shown in FIG. 7, the vehicle may include a controller 790. Controller 790 may include a device processor and a non-transitory computer readable medium including instructions stored thereon and executable by the device processor for controlling articulation of the vehicle. Controller 790 may have similar characteristics and features as controller 260 discussed above.

In some embodiments, the computer readable medium of controller 790 may include instructions for performing the following steps: applying a first level of drive power to the first front wheel, and applying a second level of drive power to the second front wheel to drive the second front wheel at a slower speed than the first front wheel. That is, a different amount of torque may be applied to each front wheel in order to drive the wheels at different speeds.

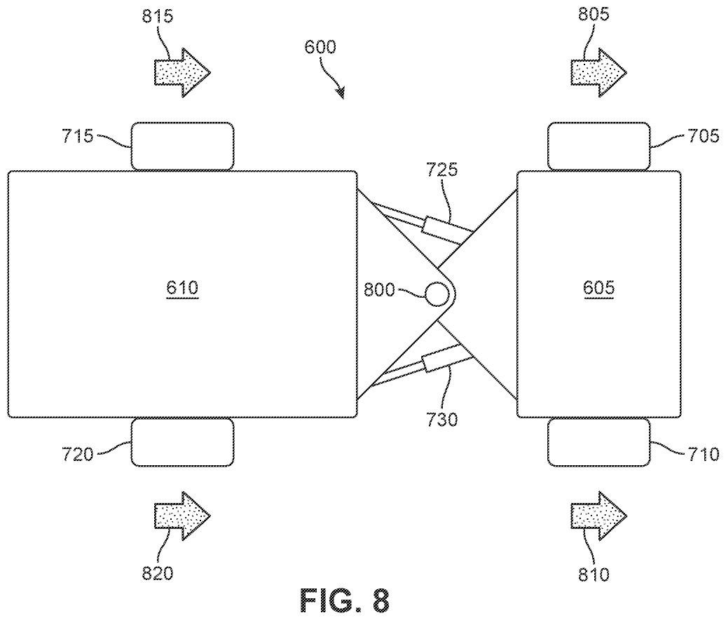

FIG. 8 is a schematic top view of the vehicle of FIG. 6 unarticulated and traveling in a straight line. While traveling in a straight line, the wheel speed may be substantially the same at each wheel, as indicated by equally sized arrows in FIG. 8. That is, a first arrow 805 indicates the wheel speed of first front wheel 705, a second arrow 810 indicates the wheel speed of second front wheel 710, a third arrow 815 indicates the wheel speed of first rear wheel 715, and a fourth arrow 820 indicates the wheel speed of second rear wheel 720. As also shown in FIG. 8, when traveling in a straight line, vehicle 600 is unarticulated about an articulating joint 800. In the unarticulated condition, first hydraulic steering cylinder 725 and second hydraulic steering cylinder 730 are substantially the same length, as shown in FIG. 8.

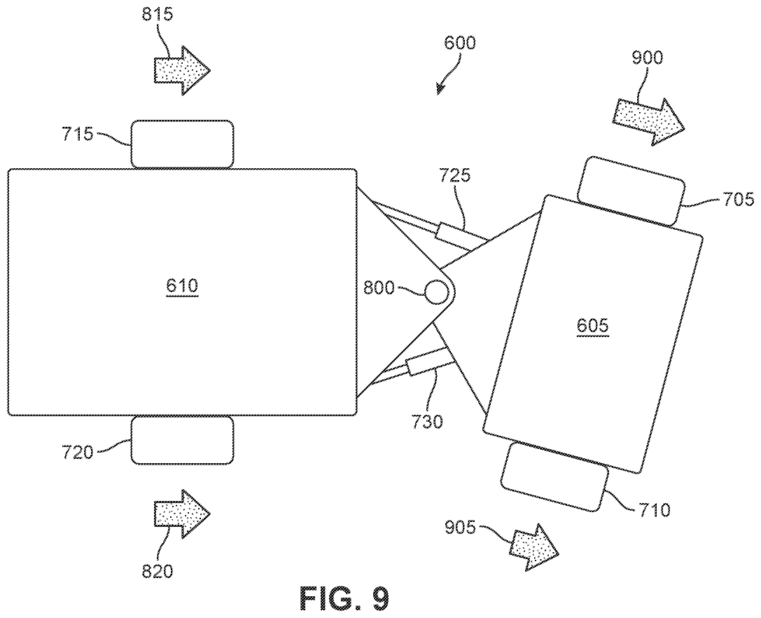

FIG. 9 is a schematic top view of the vehicle of FIG. 6 in an articulated condition. In some embodiments, the computer readable medium may include instructions for articulating the vehicle using the propulsion system. For example, the computer readable medium may include instructions for driving one of the front wheels at a different speed than the other. For example, in FIG. 9, a first arrow 900 is illustrated to be significantly larger than a second arrow 905, indicating that first front wheel 705 is being driven at a greater speed than second front wheel 710. Although not shown in FIG. 9, in some embodiments, the rear wheels may also be driven at different speeds from one another. In order to effectuate the different speeds between the rear wheels, different amounts of power (and torque) may be applied to each rear wheel.

By driving the wheels at different speeds about the vehicle, a torque may be created about articulating joint 800. The torque may be permitted to articulate the vehicle. As shown in FIG. 9, the vehicle is articulated about articulating joint 800. Notably, first hydraulic steering cylinder 725 is now longer than second hydraulic steering cylinder 730 when vehicle 600 is in the articulated condition. Thus, selective driving of individual wheels at different speeds may be utilized to steer the vehicle.

In order to facilitate this articulation via different wheel speeds, the hydraulic steering valve associated with the hydraulic steering cylinders may be opened to render the hydraulic steering system passive.

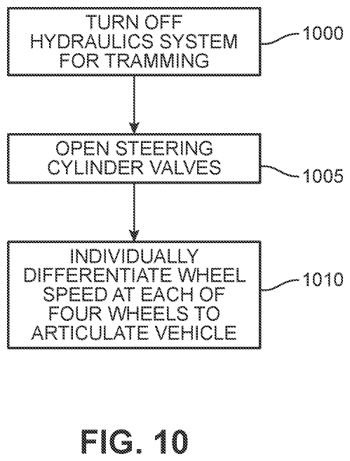

FIG. 10 is a flowchart illustrating a method of controlling articulation of the vehicle of FIG. 6. As shown in FIG. 10, the method may include turning off a hydraulic steering system, e.g., for tramming. (Step 1000.) In addition, the method may include opening the steer valve(s), thus rendering the hydraulic steering cylinders configured to be passively actuated by the articulation of the vehicle via selective driving of the individual wheels of the vehicle at different speeds. (Step 1005.) Further, the method may include individually differentiating wheel speed at each of four wheels to articulate the vehicle. (Step 1010.)

It will be noted that, in some embodiments, the non-transitory computer readable medium may further include instructions for selectively actuating brakes associated with the one or more of the wheels to counteract the application of drive power to the respective wheel in order to contribute to the articulation of the articulating joint. That is, the differentiation of wheel speed may be further augmented by the select application of braking power to individual wheels.

In some embodiments, the selectively controlling wheel speed at individual wheels may be utilized to correct the cornering line taken by a vehicle when navigating a curve. In some cases, vehicles are tasked with operating in tight areas. For example, in underground mining environments, there may be very little space for the vehicles to operate. In some mines, turns in the mining shaft may present limited space for mining vehicles to get through. The vehicles may be required to take a very precise cornering “line” in order to successfully navigate the corner.

In some embodiments, the disclosed vehicles may be configured to adjust a cornering line mid-corner. For example, with the vehicle articulated, the vehicle may drive the front wheels forward and the rear wheels rearward. The result will be that the tires scrub and the vehicle moves laterally. Similarly, the front wheels may be driven rearward and the rear wheels may be driven forward to move the vehicle laterally in the other direction.

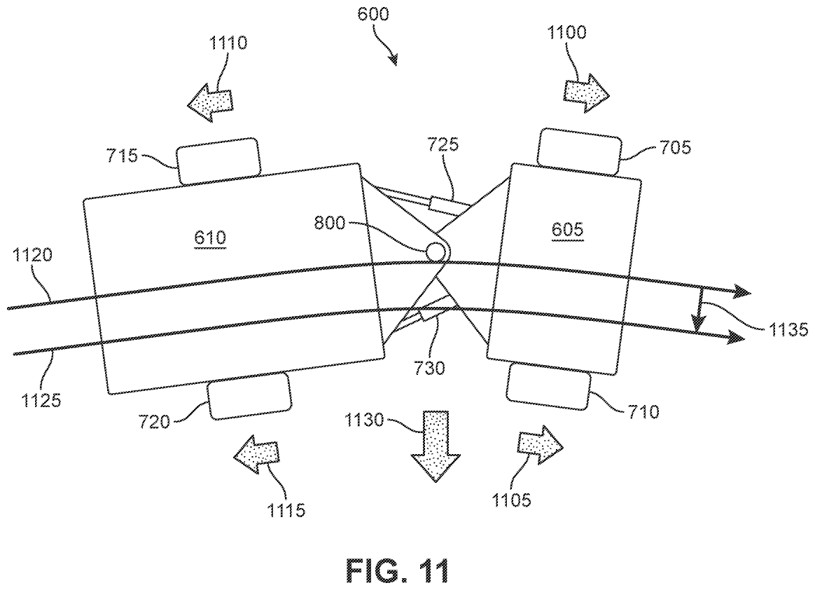

FIG. 11 is a schematic top view of the articulated vehicle of FIG. 6 making an alteration to the cornering line of the vehicle. (It will be understood that the same or similar cornering line alteration may be performed by the vehicle shown in FIG. 1 as well.) With vehicle 600 articulated as shown, the initial cornering line will be substantially as illustrated by a first line 1120.

As shown in FIG. 11, a first arrow 1100 illustrates that first front wheel 705 is being driven forward at a given speed. A second arrow 1105 illustrates that second front wheel 710 is being driven forward. A third arrow 1110 illustrates that first rear wheel 715 is being driven rearward at a given speed. A fourth arrow 1115 illustrates that the second rear wheel 720 is being driven rearward at a given speed. With the front wheels being driven in the opposite direction as the rear wheels, the wheels (tires) will scrub or spin. The result is that vehicle 600 moves in a lateral direction illustrated by an arrow 1130. Accordingly, the cornering line is changed from line 1120 to a new cornering line 1125 as shown by an arrow 1135. It will be understood that, with the vehicle articulated in the same way, the vehicle may move in the opposite lateral direction by driving the front wheels rearward and the rear wheels forward. Moreover, with the vehicle articulated in the other direction, lateral line correction may be produced by reversing the direction of wheel drive described above.

In addition, it will also be understood that the front of the vehicle may be moved more or less laterally than the rear of the vehicle by driving the front wheels at different speeds than the rear wheels. In addition, further sophistication of the line correction may be provided by driving the front wheels at different speeds than one another and/or by driving the rear wheels at different speeds than one another. It will also be understood that the different wheel speeds may be provided at individual wheels by driving individual wheel motors and/or by select braking as described above.

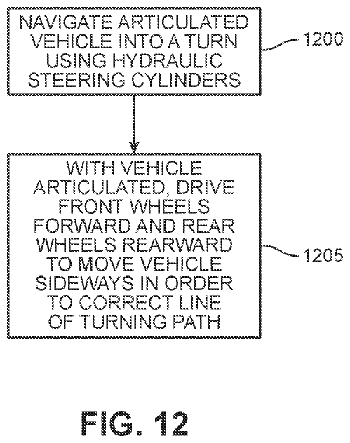

FIG. 12 is a flowchart illustrating a method of altering the cornering line of the vehicle of FIG. 6. As shown in FIG. 12, the method may include navigating an articulated vehicle into a turn using hydraulic steering cylinders. (Step 1200.) In addition, the method may include, with the vehicle articulated, driving the front wheels in a first direction and the rear wheels in the opposite direction to move the vehicle sideways in order to correct the line of the vehicles turning path. (Step 1205.)

It will be understood that the auxiliary steering methods discussed herein may be used while the vehicle is traveling forward and/or in reverse.

While various embodiments have been described, the description is intended to be exemplary, rather than limiting and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

What is claimed is:

1. An articulated vehicle, comprising:
a front chassis segment including a pair of front wheels including a first front wheel on a first side of the vehicle and a second front wheel on a second, opposite side of the vehicle;
a rear chassis segment including a pair of rear wheels, including a first rear wheel on the first side of the vehicle and a second rear wheel on the second side of the vehicle;
an articulating joint between the front chassis segment and the rear chassis segment;
at least one actuation device configured to control the articulation of the articulating joint;
a front drive system configured to drive the first front wheel and the second front wheel;
a rear drive system configured to drive the first rear wheel and the second rear wheel;
a braking system including brakes that are individually actuatable for each wheel of the vehicle; and
a controller including a device processor and a non-transitory computer readable medium including instructions stored thereon and executable by the device processor for controlling articulation of the vehicle by performing the following steps:
utilizing the front drive system to apply drive power to the pair of front wheels;
actuating brakes associated with the second front wheel to counteract the application of drive power to the second front wheel;
utilizing the rear drive system to apply drive power to the pair of rear wheels; and
actuating brakes associated with the first rear wheel to counteract the application of drive power to the first rear wheel.

2. The vehicle of claim 1, further including a locking differential configured to selectively couple the first front wheel with the second front wheel, the locking differential being controlled by the controller.

3. The vehicle of claim 1, further including an open differential enabling the first rear wheel and the second rear wheel to be rotated at different speeds from one another.

4. The vehicle of claim 1, wherein the actuation device configured to control the articulation of the articulating joint is a hydraulic cylinder.

5. The vehicle of claim 4, further including a steer valve configured to regulate operation of the hydraulic cylinder;
wherein the non-transitory computer readable medium further includes instructions for opening the steer valve to enable the hydraulic cylinder to be passively actuated by the articulation of the vehicle via selective braking of the individual wheels of the vehicle.

6. The vehicle of claim 5, further including a second hydraulic cylinder configured to articulate the articulating joint, wherein opening the steer valve renders the second hydraulic cylinder configured to be passively actuated by the articulation of the vehicle via selective braking of the individual wheels of the vehicle.

7. The vehicle of claim 4, wherein the non-transitory computer readable medium further includes instructions for turning off a hydraulic system associated with the hydraulic cylinder prior to controlling articulation of the vehicle via selective braking of the individual wheels of the vehicle.

8. The vehicle of claim 1, wherein the at least one of the front drive system and the rear drive system includes an electric motor.

9. An articulated vehicle, comprising:
a front chassis segment including a pair of front wheels including a first front wheel on a first side of the vehicle and a second front wheel on a second, opposite side of the vehicle;
a rear chassis segment including a pair of rear wheels, including a first rear wheel on the first side of the vehicle and a second rear wheel on the second side of the vehicle;
an articulating joint between the front chassis segment and the rear chassis segment;
at least one actuation device configured to control the articulation of the articulating joint;
a first electric motor configured to drive the first front wheel;
a second electric motor configured to drive the second front wheel;
a third electric motor configured to drive the first rear wheel;
a fourth electric motor configured to drive the second rear wheel; and
a controller including a device processor and a non-transitory computer readable medium including instructions stored thereon and executable by the device processor for controlling articulation of the vehicle by performing the following steps:
applying a first level of drive power to the first front wheel; and
applying a second level of drive power to the second front wheel to drive the second front wheel at a slower speed than the first front wheel.

10. The vehicle of claim 9, wherein the actuation device configured to control the articulation of the articulating joint is a hydraulic cylinder.

11. The vehicle of claim 10 further including a steer valve configured to regulate operation of the hydraulic cylinder;
wherein the non-transitory computer readable medium further includes instructions for opening the steer valve to enable the hydraulic cylinder to be passively actuated by the articulation of the vehicle via selective driving of the individual wheels of the vehicle at different speeds.

12. The vehicle of claim 11, further including a second hydraulic cylinder configured to articulate the articulating joint, wherein opening the steer valve renders the second hydraulic cylinder configured to be passively actuated by the articulation of the vehicle via selective driving of the individual wheels of the vehicle at different speeds.

13. The vehicle of claim 10, wherein the non-transitory computer readable medium further includes instructions for turning off a hydraulic system associated with the hydraulic cylinder prior to controlling articulation of the vehicle via selective driving of the individual wheels of the vehicle at different speeds.

14. The vehicle of claim 9, wherein the non-transitory computer readable medium further includes instructions for selectively actuating brakes associated with the one or more of the wheels to counteract the application of drive power to the respective wheel in order to contribute to the articulation of the articulating joint.

15. An articulated vehicle, comprising:
a front chassis segment including a pair of front wheels including a first front wheel on a first side of the vehicle and a second front wheel on a second, opposite side of the vehicle;
a rear chassis segment including a pair of rear wheels, including a first rear wheel on the first side of the vehicle and a second rear wheel on the second side of the vehicle;
an articulating joint between the front chassis segment and the rear chassis segment;
at least one actuation device configured to control the articulation of the articulating joint;
a first electric motor configured to drive the first front wheel;
a second electric motor configured to drive the second front wheel;
a third electric motor configured to drive the first rear wheel;
a fourth electric motor configured to drive the second rear wheel; and
a controller including a device processor and a non-transitory computer readable medium including instructions stored thereon and executable by the device processor for correcting a cornering line of the vehicle by performing the following steps:
driving the pair of front wheels in a first direction; and
driving the pair of rear wheels in a second direction opposite the first direction in order to move the vehicle laterally.

16. The vehicle of claim 15, wherein the actuation device configured to control the articulation of the articulating joint is a hydraulic cylinder.

17. The vehicle of claim 16, further including a steer valve configured to regulate operation of the hydraulic cylinder;
wherein the non-transitory computer readable medium further includes instructions for closing the steer valve to prevent passive actuation of the hydraulic cylinder while correcting a cornering line of the vehicle.

18. The vehicle of claim 17, further including a second hydraulic cylinder configured to articulate the articulating joint, wherein closing the steer valve prevents the second hydraulic cylinder from being passively actuated.

19. The vehicle of claim 15, wherein the non-transitory computer readable medium includes instructions for driving the pair of front wheels in a forward direction and driving the pair of rear wheels in a rearward direction simultaneously to alter the corning line of the vehicle toward an inner side of a curve.

20. The vehicle of claim 15, wherein the non-transitory computer readable medium includes instructions for driving the pair of front wheels in a rearward direction and driving the pair of rear wheels in a forward direction simultaneously to increase the radius to alter the cornering line of the vehicle toward an outer side of a curve.
